(19) United States
(12) Patent Application Publication
(10) Pub. No.: US 2023/0075006 A1
(43) Pub. Date: Mar. 9, 2023

(54) CROSSTOWN MANAGEMENT SYSTEM AND METHOD

(71) Applicant: Arthur J Gneuhs, III, Plainfield, IL (US)

(72) Inventor: Arthur J Gneuhs, III, Plainfield, IL (US)

(21) Appl. No.: 17/902,273

(22) Filed: Sep. 2, 2022

Related U.S. Application Data
(60) Provisional application No. 63/240,955, filed on Sep. 5, 2021.

(51) Int. Cl. G06Q 10/08

(52) U.S. Cl. CPC G06Q 10/083

(57) ABSTRACT

An innovative crosstown management system is disclosed. In particular, a crosstown management system manages the interchange of intermodal shipments from a first railway, port or depot to a second railway, port or depot for furtherance or storage. The utilization of drivers and throughput of loads are both maximized.

### CROSS-REFERENCE

This application claims the priority benefit of U.S. provisional application No. 63/240,955, entitled CROSSTOWN MANAGEMENT SYSTEM AND METHOD, filed Sep. 5, 2021, which is incorporated by reference herein in its entirety for all purposes.

### FIELD OF THE DISCLOSURE

The present disclosure relates to a crosstown management system. More particularly, it relates to a crosstown management software system, and a method of using the software system to manage the rubber tire interchange of intermodal shipments from one railway, port or depot to another railway, port or depot for furtherance or storage purposes.

### BACKGROUND

Typically, containers arrive at a railway, port, or depot and, given the lack of short rail or interchange rail between all locations, are transported via truck from one yard to another for said purposes. Many times yards are located within reasonable distances of one another; i.e., within fifty miles or so, or 0.5-2 hours via truck.

Presently, there are a number of inefficiencies inherent in the transportation of intermodal interchange traffic. First, there is a shortage of trained truck drivers. This situation has been present for at least a decade and has only been getting worse. Second, drayage contracts between cargo owners and/or entities charged with executing these interchanges and particular trucking companies lead to a situation where a truck operator drops off a load and then has to leave with no return load even though there are many loads available for pickup. This results in two major issues. First, the driver bobtails from the yard, unpaid, to wherever his company has contracted moves. Second, the facility he has bobtailed from remains congested and the units left behind potentially fail service. The high number of zero-load trips (bobtails) out of yards leads to a number of inefficiencies, including higher costs, lower driver utilization, increased fuel usage, increased emissions, and other issues. A need therefore exists for a system that addresses these inefficiencies.

### SUMMARY

According to an aspect of the disclosure, a crosstown management system comprises system hardware and system software, the system hardware comprising at least one system server comprising a processor and a memory, at least one cargo owner electronic device comprising a processor and a memory, and at least one trucking electronic device comprising a processor and a memory. The system software comprises instructions to receive, by the system server, a plurality of interchange candidates from the cargo owner electronic device and a plurality of workload requests transmitted by a plurality of drivers from the trucking electronic device, each of the interchange candidates comprising cargo data representing a specific cargo unit, the plurality of workload requests collectively constituting a workload request set. Further, the system software comprises instructions to compute, by the system hardware executing a route assignment algorithm, the route assignment algorithm defining route assignment algorithm criteria, a route assignment set including an assigned route corresponding to each workload request of the workload request set, the route assignment set satisfying the route assignment algorithm criteria. In addition, the system software comprises instructions to assign a route to each of the workload requests, by the system server communicating the corresponding route assignment from the route assignment set to the trucking electronic device from which the workload request was transmitted.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1 is a system block diagram illustrating the major components of a crosstown management system as described herein;

FIG. 2 is a simplified flow chart of a route assignment method for use with the crosstown management system described herein;

FIG. 3 is a flow chart of an algorithm of for scoring a collection of potential routes to determine an optimal route for use with the crosstown management system described herein;

FIG. 4 is an alternate route assignment method for use with the crosstown management system described herein.

A person of ordinary skill in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skills in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed system and method, reference is made to the accompanying drawings, which form a part hereof, and in which are shown by way of illustration various example devices, systems, and environments in which aspects of the disclosed system and method can be practiced. Other specific arrangements of parts, example devices, systems, and environments, can be used, and structural modifications and functional modifications can be made without departing from the scope of the disclosed system and method.

As illustrated in the accompanying drawings and described herein, the present disclosure provides a crosstown management software system and a method of using the system to manage the interchange of intermodal shipments from one railway, port or depot to another railway, port or depot (collectively “hubs”) for furtherance or storage purposes.

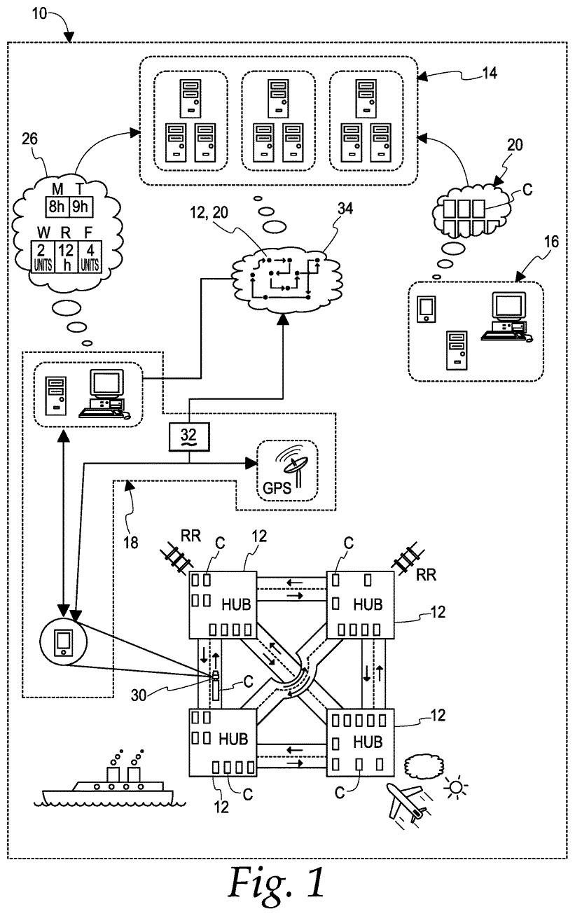

With reference to FIG. 1, a computerized crosstown management system 10 for providing intermodal interchange between hubs 12 is illustrated. The system 10 comprises software running on one or more system servers or server clusters (system server 14), one or more cargo owner/responsible entity electronic devices (owner electronic device 16) and one or more trucking electronic devices (trucking electronic device 18). Each of the system server 14, the owner electronic device 16, and the trucking electronic device 18 comprises at least one processor and a non-volatile memory and is operative to run the system software or part of the system software. Any server or server cluster of the one or more system servers or server clusters, if plural, may be operative to perform a subset of, or all, the server functions described herein, either independently of or in response to input from one or more other servers or server clusters, and either solely or in conjunction with one or more other servers or server clusters. Unless otherwise specified, the term “system server 14” means one, all, or a subset of the one or more system servers or server clusters, and the term “processor” means one, all, or a subset of the processors of the system server 14, owner electronic device 16, and trucking electronic device 18, as applicable in the context of the embodiment(s) described.

In embodiments, the owner electronic device 16 comprises one or more smartphones or other handheld computing devices, one or more user-operated personal owner desktop or laptop computers, and/or one or more servers or server clusters. In embodiments, the trucking electronic device 18 comprises a driver's electronic logging device or “ELD,” smartphone, or other mobile electronic device. In other embodiments, the trucking electronic device 18 further comprises one or more user-operated personal owner desktop or laptop computers, and/or one or more servers or server clusters, linked to the mobile electronic device, for push and/or pull data transfers. The system server 14 is adapted and configured to send data to and receive data from the owner electronic device 16 and the trucking electronic device 18.

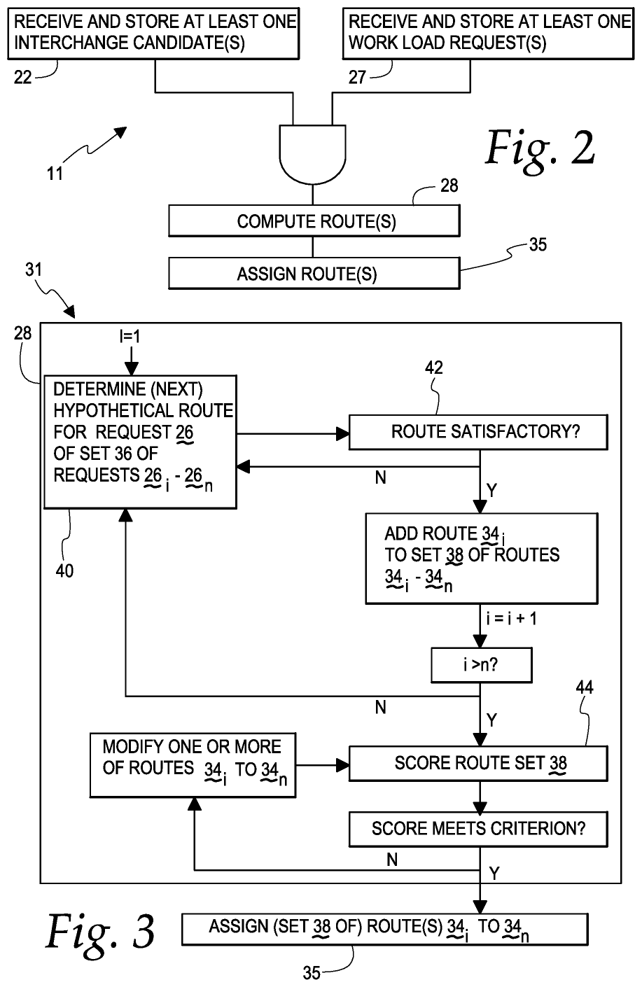

FIG. 2 is an illustration of a crosstown management method 11, which uses the crosstown management system 10. In an interchange candidate receiving and storing step 22 of the method 11, the system server 14 receives and stores interchange candidates 20 uploaded by cargo owners and/or responsible entities from owner electronic devices 16. In embodiments, a “responsible entity” can be any entity charged with executing intermodal interchanges of cargo from one hub 12 to another hub 12 for furtherance or storage or otherwise authorized by an owner of the cargo to transmit the interchange candidates 20 concerning the cargo to the system server 14. For example, a responsible entity can be a railroad, truckload carrier, LTL carrier, chassis owner, or 3PL company. In embodiments, an interchange candidate 20 comprises data representing a specific cargo unit C. More particularly, the interchange candidate 20 includes a cargo unit code (e.g., a cargo unit initial and number), a cargo origin hub and cargo destination hub (referred to as an o/d pair), a cargo unit size (length), an indication of whether the cargo unit C includes hazardous materials, and a cut-off date or appointment time for delivery of the cargo unit C to a destination terminal. Optionally, the interchange candidate 20 includes an indication of priority or time sensitivity, special instructions, and/or the identity(/ies) of the owner or responsible entity and/or addressee or intended recipient. In parallel with receiving and storing interchange candidates in step 22, the system server 14 is adapted and configured to receive workload requests 26 uploaded by individual drivers 30 (or their trucking companies, e.g.) from the trucking electronic device 18, in a workload request receiving step 27.

In embodiments, the workload request 26 comprises workload request data, the workload request data including a requested amount of work, such as a number of hours (which can be a whole number or mixed/decimal number of hours; i.e., any amount of time) a driver requests to work and/or a number of units a driver requests to handle, during a specified time period corresponding to the request, such as for a given day or week, or for even longer time periods, such as for a given month or year. In an embodiment, the system 10 is adapted and configured so that the server 14 can receive and will accept a workload request 26 for whatever time period an individual driver or trucking company chooses to specify. In other embodiments, the system 10 is adapted to limit what time periods may be specified in a workload request 26. For example, the software may instruct the trucking electronic device 18 to generate a user interface that will prompt for and only accept driver-specified time periods meeting specified criteria and/or instruct the server 14 to accept the workload request only if the driver-specified time period meets such criteria. For example, the criteria may include that the driver-specified time period be of at least a minimum duration, be of no greater than a maximum duration, be of a whole number of time units of duration, be selected by the driver from a finite number of predefined options, and/or begin and/or end within certain constraints. Such constraints may include, for example, that the driver-specified time period for the workload request 26 begin or end no sooner than X hours/minutes from the time of its submission and/or that the driver-specified time period begin or end no later than Y hours/minutes/days from the time of its submission. In some embodiments that include constraints on the duration, start time, or end time of a time period that the server 14 will accept for a workload request 26, the constraints are the same for all drivers 30. In other embodiments, the constraints may differ depending on the individual driver 30, for example, as specified by the trucking company that employs or contracts with the driver 30, and/or as determined by a formula. In embodiments, a formula for calculating constraints on an individual driver's driver-specified time period that can be input to the individual driver's trucking device, and/or that will be accepted by the system server in a workload request from the individual driver, is based on data about a driver's prior service stored by a system server. The individual driver's prior service data can include a number of completed hours of service or a number of completed cargo unit interchanges already logged by the driver 30 and stored by the server 26 during a past time period specified by the system software.

The software includes instructions for the processor to execute a route assignment algorithm 31, shown in FIG. 3, including a route computation step 28 and a route assignment step 35. In the route computation step 28, the processor computes a route 34 for each driver 30 in response to the workload request 26 submitted by the driver 30. A route 34 includes one or more pickups and drop-offs, the pickups and drop-offs being determined, at least in part by a plurality of the interchange candidates 20, which are selected to be assigned to the route 34. In the route assignment step 35, the processor assigns one or more routes 34 to one or more corresponding workload requests 26. The algorithm 31 utilizes GPS data 32 corresponding to a specific driver 30 to compute and assign a route 34 for that driver 30. In embodiments, the GPS data 32 is logged by a trucking electronic device 18 carried by a specific driver/driver 30 or a corresponding specific tractor/truck cab, such as a registered driver's ELD or mobile phone. The computed route 34 includes pickups and deliveries of the cargo unit C from hubs 12 during a time period corresponding to the workload request 26 submitted by the driver 30. In the route assignment step 35, the computed route 34 for each driver 30 is transmitted by the system servers 14 to the trucking electronic device 18.

In the route computation step 28, each driver 30 is assigned a route 34 by the system 10, the assigned route 34 including a sequence of the driver dropping off one or more cargo units C at a hub 12, then picking up one or more new units that need to be moved from a hub 12 (preferably the same hub 12 at which the driver 30 last dropped off one or more units, at the time of, or soon after, the last drop-off, thus to avoid a bobtail or significant delay), as specified by one or more interchange candidates 20, then taking the new unit(s) to a new hub 12 as indicated, and to continue that process for all pickups and drop-offs included in the assigned route 34. In an embodiment, the algorithm 31 is operative to assign to a driver 30 an assigned route 34 that corresponds closely to the hours and/or units specified in the driver's workload request 26, within constraints of the algorithm. Assigned routes 34 may be computed using linear algebra and other well-known techniques, such as, for example, the well-known Clarke-Wright (C/W) algorithm, which is described in “A Heuristic Approach Based on Clarke-Wright Algorithm for Open Vehicle Routing Problem,” Pichpibul et al., Hindawi Publishing Corp, 2013, which is included herein by reference in the entirety.

As illustrated in FIG. 3, the route computation step 28 of the algorithm 31 includes the processor receiving a set of workload requests 26₁-26ₙ (workload request set 36), computing a set of routes 34₁ to 34ₙ (route assignment set 38), and assigning the routes 34 assignment set 38 to the respective workload requests 26₁-26ₙ corresponding to the workload request set 36, as follows. In a route determining sub-step 40 of the route computation step 28, the processor determines a hypothetical route for a particular workload request 26ᵢ that assigns to the corresponding driver 30 exactly or very nearly the driver's requested workload, while maximizing or otherwise optimizing driver utilization over the course of the route, by minimizing or otherwise limiting driver time spent idle, bobtailing, or otherwise engaged in unproductive and/or uncompensated activity. The processor then attempts to reconcile that hypothetical route with algorithm criteria (such as described further below), in a route testing step 42. When the processor is unable to reconcile the hypothetical route with the algorithm criteria, the processor rejects the hypothetical route as an unsatisfactory route and proceeds to identify a next hypothetical route for the workload request 26ᵢ, until a hypothetical route is identified as a satisfactory route, a satisfactory route being a hypothetical route which allows the algorithm criteria to be satisfied.

The processor then repeats the foregoing for the next workload request 26ᵢ₊₁, until a complete set of satisfactory routes, corresponding to a respective complete set 36 of received workload requests 26₁ to 26ₙ, has been identified. In an embodiment, the processor designates the satisfactory route set thus identified as the route assignment set 38 and assigns the routes 34₁ through 34ₙ of the assignment set 38 to the respective workload requests 26₁ to 26ₙ, by causing the system server 14 to transmit each route of the route assignment set 38 to the trucking electronic device 18 corresponding to the respective driver 30. In embodiments, the route computation step 28 includes a scoring step 44 a hypothetical route set 38 is assigned a score, based on a degree to which the hypothetical satisfactory routes 34₁ to 34ₙ of the set meets or exceeds algorithm criteria. The algorithm may impose a further criterion on this score itself, such as that the score meet or exceed a required minimum score, that the score be the relatively best score of all possible route sets 38, or that the score be the relatively best score of a sample selection of possible route sets 38.

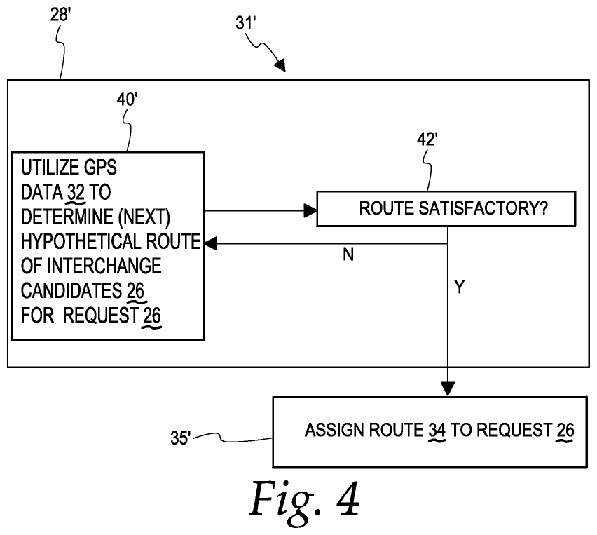

In other embodiments of a route assignment algorithm 31′, as illustrated in FIG. 4, a route computation step 28′ includes computing only a single route 34′ by looping a step 40′ of determining a (next) hypothetical route with a step 42′ of determining whether assigning the hypothetical route would allow algorithm criteria to be satisfied. According to the algorithm 31′, upon determining that a single route 34 is satisfactory, the processor assigns the route 34 to the currently pending workload request 26 in a route assignment step 35′. Drivers 30 are thus assigned routes 34′ in the order in which their workload requests 26 are received, without the processor necessarily determining or evaluating hypothetical routes 34′ for any subsequently received workload request 26.

In embodiments, an assigned route 34, 34′ responsive to a workload request 26 is subject to change, by adding or removing interchange candidates 20 to or from the route 34 after it has been assigned. Such modification of one more previously assigned routes 34 may be triggered by the receipt of one or more new interchange candidates 20 and/or one or more new workload requests 26. For example, when a new interchange candidate 20 is received before a new workload request 26, the new interchange candidate 20 may be added to a previously assigned route 34, with or without reassigning one or more interchange candidates 20 between/among the previously assigned route 34 and other previously assigned routes 34, to satisfy algorithm criteria and/or to improve a resulting score of one or more assigned routes 34, such as a score of all pending or in-progress routes 34. In another example, one or more previously assigned routes 34 are modified when a satisfactory new route 34 cannot be determined and assigned to a newly received workload request 26 without such modification. In another example, in response to a newly received workload request 26 and/or interchange candidate 20, previously assigned routes 34 are modified when a processor determines that such modification would improve an outcome score over the best possible outcome score (or the best of a sample of possible outcome scores) attainable without such modification.

In an embodiment, modification of previously assigned routes 34 is itself a factor that reduces a resulting outcome score, as such modification may be detrimental to driver morale and/or increase the likelihood of inefficiencies caused by driver error in overlooking the modification, particularly when a route in progress is modified. However, in embodiments, to reduce the occurrence of such errors/inefficiencies, the addition or removal of an interchange candidate 20 from a driver's route 34 will not be assigned and communicated to the driver 30 until the server 14 has transmitted a change request to, and in response received a confirmation transmission from, the trucking electronic device(s) 18 of the affected driver(s) 30. The confirmation transmission can be initiated either manually, by the affected driver(s) 30, or automatically, by the trucking electronic device 18 executing software instructions. In an embodiment in which such modification is automatically confirmed by the associated trucking electronic device 18, the likelihood of this causing driver error is reduced by the trucking electronic device 18 automatically updating a set of live navigation instructions to be presented to the driver 30 during the course of the driver's modified assigned route 34.

In embodiments, the system algorithm criteria referred to in the foregoing include one or more of the following criteria. In an embodiment, the criteria include assigning each requesting driver 30 a route that deviates by no more than a specified measure from the driver's workload request 26, maximizes or otherwise optimizes the driver's utilization throughout the course of the route, complies with any applicable workload limits or restrictions (which may include legal or contractual restrictions, where a given restriction may apply to all drivers 30 or to a particular driver 30 or class of drivers 30), and meets one or more specified criteria for expediting the movement of interchange candidates 20. In embodiments, the criteria include maximizing the total income earned by (and thus the corresponding productivity of) the drivers 30 collectively for a given workday or other time period corresponding to a workload request set 36, while staying within legal workload limits for all drivers 30, assigning each driver a workload that deviates from the driver's requested workload, according to a defined workload deviation measure, by no more than a defined limit or limits. In an embodiment, a workload deviation measure is a linear difference between a number of hours assigned to a driver 30 and a number of hours requested by the driver 30 in the driver's workload request 26. In another embodiment, a workload deviation measure is a percentage of the requested hours by which the assigned hours linearly differ from the requested hours. In embodiments, the criteria include a uniform compensation criterion, which, for example, limits the amount by which the utilization rate of a given driver 30 may differ from that of any other driver 30. In an embodiment, the uniform compensation criterion accounts only for a currently pending set of workload requests 26. In another embodiment, the uniform compensation criterion attempts to level the cumulative utilization of drivers 30 by distributing utilization across a presently calculated route assignment set so as to submitting the currently pending workload request set 36. In an embodiment, a utilization rate is an effective rate of compensation for a driver 30, such as an hourly or per-unit compensation rate, for a single assigned route 34, or cumulatively over a number of assigned routes 34, number of hours worked, number of units delivered, and/or for a particular pay period or periods.

In view of the foregoing, it is believed that implementation of the system 10 benefits drivers 30 individually and collectively. Also, the yards (i.e., hubs 12), cargo owners, and responsible parties realize increased velocity, reduced yard/hub congestion.

The preceding description of the disclosure has been presented for purposes of illustration and description and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A crosstown management system comprising:
system hardware, the system hardware comprising at least one system server comprising a processor and a memory, at least one cargo owner electronic device comprising a processor and a memory, at least one trucking electronic device comprising a processor and a memory;
system software, the system software comprising instructions to:
receive, by the system server, a plurality of interchange candidates from the cargo owner electronic device and a plurality of workload requests transmitted by a plurality of drivers from the trucking electronic device, each of the interchange candidates comprising cargo data representing a specific cargo unit, the plurality of workload requests collectively constituting a workload request set;
compute a route assignment set by the system hardware executing a route assignment algorithm, the route assignment algorithm defining route assignment algorithm criteria, the route assignment set including a route assignment corresponding to each workload request of the workload request set, the route assignment set satisfying the route assignment algorithm criteria;
assign a route to each of the workload requests, by the system server communicating the corresponding route assignment from the route assignment set to the trucking electronic device from which the workload request was transmitted.

2. The crosstown management system of claim 1 wherein each of the interchange candidates corresponds to a cargo unit and comprises a cargo unit code, a cargo origin hub and cargo destination hub constituting an o/d pair, a cargo size, an indication of whether the cargo includes hazardous materials, and a cut-off date or appointment time for delivery of the cargo unit to a destination terminal.

3. The crosstown management system of claim 1 wherein the route assignment algorithm includes, after assigning a first route to a first one of the workload requests from a first one of the drivers, the first route including a first o/d pair of a first one of the interchange candidates:
receiving, by the server, a second one of the workload requests or a second one of the interchange candidates; and
in response to receiving the second workload request or second interchange candidate, modifying the first route.

4. The crosstown management system of claim 3 wherein said modifying the first route includes assigning a second o/d pair of the second interchange candidate to the first route.

5. The crosstown management system of claim 3 wherein said modifying the first route includes reassigning the first o/d pair from the first route to a second route and assigning the second route to the second workload request.

6. The crosstown management system of claim 3 wherein said modifying the first route includes the server transmitting a change request indicating a first route change to the trucking electronic device of the first driver, the trucking electronic device transmitting a confirmation to the server in response to the change request transmission, and the server assigning the first route change in response to the confirmation transmission.

7. The crosstown management system of claim 6 wherein the system software includes instructions for the trucking electronic device to prompt the first driver to confirm the first route change and to receive manual input from the first driver to initiate the confirmation transmission.

8. The crosstown management system of claim 6 wherein the system software includes instructions for the trucking electronic device to initiate the confirmation transmission to the server automatically in response to receiving the change request transmission.

9. The crosstown management system of claim 8 wherein the system software includes instructions for the trucking electronic device to update automatically a set of live navigation instructions to be presented to the first driver during the course of the modified first route.

10. The crosstown management system of claim 2 wherein each assigned route corresponds to one or more of the interchange candidates and includes a specified sequence for the corresponding driver to complete at least one cargo pickup and at least one cargo drop-off, each cargo pickup comprising the driver picking up the cargo unit corresponding to an interchange candidate at the corresponding cargo origin hub at a corresponding time, each cargo drop-off comprising the driver dropping off the cargo unit corresponding to an interchange candidate at the corresponding cargo destination hub at a corresponding time.

11. The crosstown management system of claim 2 wherein at least one of the interchange candidates comprises optional cargo unit data, the optional cargo unit data being selected from an indication of priority of a delivery of the cargo unit to the cargo destination, an indication of time sensitivity of said delivery, special instructions for the cargo unit, an owner identity, a responsible entity identity, an addressee identity, and an intended recipient identity.

12. The crosstown management system of claim 1 wherein the workload request comprises workload request data, the workload request data comprising an amount of work requested by the driver for a specified time period, the requested amount of work being selected from a number of hours and a number of cargo unit interchanges.

13. The crosstown management system of claim 5 wherein the route assignment algorithm includes:
before assigning an individual route to any individual workload request of the workload request set, generating a plurality of hypothetical route assignment sets and assigning a score to each of the plurality of hypothetical route assignment sets, the score of each hypothetical route assignment set being based on a degree to which individual drivers' routes of the hypothetical route assignment set correspond closely to the requested amount of work of the individual drivers' workload requests and a degree to which the individual drivers routes of the hypothetical route assignment set limit the amount of the drivers' time spent on unproductive and/or uncompensated activity; and
assigning to the each individual workload request the corresponding route of the hypothetical route assignment set having the best assigned score of the plurality of hypothetical route assignment sets.

14. The crosstown management system of claim 5 wherein the instructions to receive the plurality of workload requests comprise instructions to receive a workload request of which the specified time period is a driver-specified time period.

15. The crosstown management system of claim 7 wherein the system software further comprises instructions for the trucking electronic device to prompt for and receive user input of the driver-specified time period subject to time period input constraints, the time period input constraints comprising at least one constraint selected from a time period maximum duration, a time period minimum duration, a requirement of a time period duration equal to a whole number of time units, a time period start time constraint, a time period end time constraint, and/or a requirement of a time period selected from a finite selection of predefined time periods.

16. The crosstown management system of claim 8 wherein the software further comprises instructions to apply the same time period input constraints to each driver-specified time period of each of the plurality of drivers.

17. The crosstown management system of claim 8 wherein the time period input constraints comprise computed driver-specific time period input constraints for each individual driver of the plurality of drivers, the software further comprising instructions for the server to store prior service data for the individual driver and to compute the driver-specific time period input constraints for the individual driver based on the individual driver's prior service data.

18. The crosstown management system of claim 10 wherein the individual driver's prior service data includes prior service data selected from a number of completed hours of service and a number of completed cargo unit interchanges stored by the server for the individual driver.

19. The crosstown management system of claim 1 wherein the route assignment algorithm includes computing and assigning an individual route for each of the plurality of workload requests in the order in which the workload request is received by the server, before computing or assigning an individual route for any workload request subsequently received by the server.
